(19) United States
(12) Patent Application Publication
(10) Pub. No.: US 2025/0115163 A1
(43) Pub. Date: Apr. 10, 2025

(54) ONBOARD HIGH-VOLTAGE SYSTEM AND ELECTRONIC CONTROL UNIT

(71) Applicant: DENSO CORPORAITON, Kariya-city (JP)

(72) Inventors: Toshitada SANZEN, Kariya-city (JP); Koji Sakai, Kariya-city (JP)

(21) Appl. No.: 18/985,578

(22) Filed: Dec. 18, 2024

Related U.S. Application Data
(63) Continuation of application No. PCT/JP2023/021902, filed on Jun. 13, 2023.

(30) Foreign Application Priority Data
Jun. 29, 2022 (JP) 2022-104702

(51) Int. Cl. B60L 58/25; B60L 50/60; H01M 10/615; H01M 10/625; H01M 10/633

(52) U.S. Cl. CPC B60L 58/25; B60L 50/60; H01M 10/615; H01M 10/625; H01M 10/633

(57) ABSTRACT

An onboard high-voltage system includes a temperature-increase device, a high-voltage auxiliary device, an electronic control unit. The temperature-increase device is connected to the high-voltage battery through an electric circuit. The temperature-increase device is capable of executing a battery temperature-increase operation to increase a temperature of the high-voltage battery by turning on and off a switching element included in the temperature-increase device to charge and discharge the high-voltage battery. The high-voltage auxiliary device is connected to the electric circuit, and is driven by power supplied from the high-voltage battery. The electronic control unit executes a warm-up operation to warm up a smoothing capacitor included in the high-voltage auxiliary device or the temperature-increase device prior to the battery temperature-increase operation, and prevents a voltage fluctuation or a current fluctuation during the battery temperature-increase operation from exceeding a tolerance value of each component in the high-voltage auxiliary device.

### CROSS REFERENCE TO RELATED APPLICATIONS

The present application is a continuation application of International Patent Application No. PCT/JP2023/021902 filed on Jun. 13, 2023, which designated the U.S. and claims the benefit of priority from Japanese Patent Application No. 2022-104702 filed on Jun. 29, 2022. The entire disclosures of all of the above applications are incorporated herein by reference.

### TECHNICAL FIELD

The present disclosure relates to an onboard high-voltage system and an electronic control unit used in the onboard high-voltage system.

### BACKGROUND

Onboard high-voltage systems may be installed in vehicles such as electric vehicles, hybrid vehicles, or plug-in hybrid vehicles. An onboard high-voltage system may include a high-voltage battery, a main inverter that drives a traction motor connected to the high-voltage battery via an electric circuit, and a high-voltage auxiliary device.

### SUMMARY

The present disclosure describes an onboard high-voltage system including a high-voltage battery, a temperature-increase device, a high-voltage auxiliary device, a smoothing capacitor, and an electronic control unit, and further describes an electronic control unit that is adapted to an onboard high-voltage system.

### BRIEF DESCRIPTION OF DRAWINGS

Objects, features and advantages of the present disclosure will become more apparent from the following detailed description made with reference to the accompanying drawings. In the drawings:

FIG. 1 illustrates a schematic configuration of an onboard high-voltage system according to a first embodiment;

FIG. 2 is a flowchart that illustrates an example of a control process executed by an auxiliary ECU included in the onboard high-voltage system according to the first embodiment;

FIG. 3 is a flowchart that illustrates an example of a control process executed by an auxiliary ECU included in an onboard high-voltage system according to a second embodiment;

FIG. 4 is a flowchart illustrating an example of a control process executed by a temperature-increase ECU included in an onboard high-voltage system according to a third embodiment;

FIG. 5 is a flowchart illustrating an example of a control process executed by a temperature-increase ECU included in an onboard high-voltage system according to a fourth embodiment;

FIG. 6 illustrates a schematic configuration of an onboard high-voltage system according to a fifth embodiment;

FIG. 7 is a flowchart illustrating an example of a control process executed by a temperature-increase ECU included in the onboard high-voltage system according to the fifth embodiment;

FIG. 8 is a table illustrating an example of the combination of the temperature states of smoothing capacitors, each associated with multiple high-voltage auxiliary device, and the temperature-increase limitation operation mode executed by the temperature-increase ECU in the onboard high-voltage system according to the fifth embodiment; and

FIG. 9 is a flowchart illustrating an example of a control process executed by a temperature-increase ECU included in an onboard high-voltage system according to the sixth embodiment.

### DETAILED DESCRIPTION

An onboard high-voltage system may perform a battery temperature-increase operation in a low-temperature environment by charging and discharging the high-voltage battery through the operation of high-voltage equipment such as inverters, boost converters, and DC-DC converters, thereby raising the temperature of the high-voltage battery. This may prevent performance degradation of the high-voltage battery in the low-temperature environment.

However, when performing the battery temperature-increase operation as in the above-mentioned onboard high-voltage system, a ripple current also flows into the high-voltage auxiliary device connected to the high-voltage battery via an electric circuit. And, if components (for example, electrolytic capacitors) with the characteristic that their internal resistance increases as the temperature decreases are used in the input filter of the high-voltage auxiliary device, the internal resistance of the smoothing capacitor may increase in the low-temperature environment. As a result, when the ripple current flows in, an excessive surge voltage may occur, potentially causing the components of the high-voltage auxiliary device to be degraded.

According to a first aspect of the present disclosure, an onboard high-voltage system is adapted to a vehicle. The on-board high-voltage system includes a high-voltage battery, a temperature-increase device, a high-voltage auxiliary device, a smoothing capacitor, and an electronic control unit. The high-voltage battery stores and releases electric power. The temperature-increase device is connected to the high-voltage battery via an electric circuit. The temperature-increase device has a switching element. The temperature-increase device executes a battery temperature-increase operation to increase a temperature of the high-voltage battery by turning on and off the switching element to cause the high-voltage battery to store and release the electric power. The high-voltage auxiliary device is electrically connected to the electric circuit that connects the high-voltage battery to the temperature-increase device. The high-voltage auxiliary device is driven by the electric power supplied from the high-voltage battery. The smoothing capacitor has a terminal connected to a power supply wiring and another terminal connected to a ground wiring. The power supply wiring is a wiring through which the electric power is supplied from the high-voltage battery to the high-voltage auxiliary. The smoothing capacitor has an internal resistance value that increases as a temperature of the smoothing capacitor decreases. The electronic control unit executes a warm-up operation to warm up the smoothing capacitor included in the high-voltage auxiliary device by turning on and off the high-voltage auxiliary device or the switching element included in the temperature-increase device, prior to execution of the battery temperature-increase operation, and ensures that a voltage fluctuation or a current fluctuation occurred in the high-voltage auxiliary device during the battery temperature-increase operation does not exceed a tolerance value of each component in the high-voltage auxiliary device.

Accordingly, the smoothing capacitor of the high-voltage auxiliary device has the characteristic that its internal resistance increases as the temperature decreases. Therefore, by increasing the temperature of the smoothing capacitor of the high-voltage auxiliary device prior to performing the battery temperature-increase operation, it is possible to lower the internal resistance of the smoothing capacitor and reduce the surge voltage that occurs when the ripple current flows into the high-voltage auxiliary device during the battery temperature-increase operation. Therefore, this onboard high-voltage system can prevent the components of the high-voltage auxiliary device from becoming degraded during the battery temperature-increase operation.

According to a second aspect of the present disclosure, an electronic control unit is adapted to an onboard high-voltage system. The on-board high-voltage system includes a high-voltage battery, a temperature-increase device, a high-voltage auxiliary device, and a smoothing capacitor. The high-voltage battery stores and releases electric power. The temperature-increase device is connected to the high-voltage battery via an electric circuit. The temperature-increase device has a switching element. The temperature-increase device executes a battery temperature-increase operation to increase a temperature of the high-voltage battery by turning on and off the switching element to cause the high-voltage battery to store and release the electric power. The high-voltage auxiliary device is electrically connected to the electric circuit that connects the high-voltage battery to the temperature-increase device. The high-voltage auxiliary device is driven by the electric power supplied from the high-voltage battery. The smoothing capacitor has a terminal connected to a power supply wiring and another terminal connected to a ground wiring. The power supply wiring is a wiring through which the electric power is supplied from the high-voltage battery to the high-voltage auxiliary. The smoothing capacitor has an internal resistance value that increases as a temperature of the smoothing capacitor decreases. The electronic control unit executes a warm-up operation to warm up the smoothing capacitor included in the high-voltage auxiliary device by turning on and off the high-voltage auxiliary device or the switching element included in the temperature-increase device, prior to execution of the battery temperature-increase operation, and ensures that a voltage fluctuation or a current fluctuation occurred in the high-voltage auxiliary device during the battery temperature-increase operation does not exceed a tolerance value of each component in the high-voltage auxiliary device.

Even in this case, the similar advantages with those of the first aspect can be obtained. In the following description, the electronic control unit may also be referred to as ECU.

Several embodiments of the present disclosure will be described with reference to the drawings in the following. Parts that are identical or equivalent to each other in the following embodiments are assigned the same reference numerals and will not be described.

### First Embodiment

A first embodiment will be described with reference to the drawings. An onboard high-voltage system according to the present embodiment is installed in, for example, an electric vehicle, a hybrid vehicle, or a plug-in hybrid vehicle. The onboard high-voltage system may also be referred to as a high-voltage system in the following.

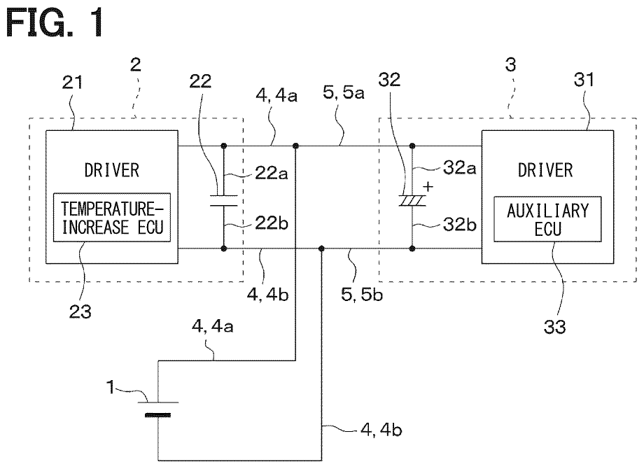

As shown in FIG. 1, the high-voltage system includes, for example, a high-voltage battery 1, a temperature-increase device 2, and high-voltage auxiliary device 3. The temperature-increase device 2 may also be referred to as a heating device or a warming device. Although FIG. 1 describes a single high-voltage auxiliary device 3, the high-voltage system is not limited to this example and may include multiple high-voltage auxiliary device 3.

The high-voltage battery 1 is a secondary battery capable of storing and releasing electric power, and includes, for example, a lithium-ion battery. Generally, the high-voltage battery 1 has an issue with performance degradation at low temperatures, which can be improved by using it after increasing the temperature of the high-voltage battery 1.

The high-voltage battery 1, the temperature-increase device 2 and the high-voltage auxiliary device 3 are connected by electric circuits 4, 5. Electric circuits 4 and 5 are constructed by high-voltage cables. The high-voltage battery 1 supplies electric power to the temperature-increase device 2 via the electric circuit 4 and also supplies power to the high-voltage auxiliary device 3 via another electric circuit 5 connected in parallel to the electric circuit 4. In the following description, the electric circuit 4 that connects the high-voltage battery 1 and the temperature-increase device 2 may also be referred to as a first electric circuit 4. The electric circuit 5 that connects the first electric circuit 4 and the high-voltage auxiliary device 3 may also be referred to as a second electric circuit 5.

The temperature-increase device 2 includes, for example, a driver 21 and a smoothing capacitor 22. The driver 21 includes an inverter circuit including multiple switching elements. The driver 21 converts the direct current supplied from the high-voltage battery 1 into an alternating current (specifically, a three-phase alternating current) and supplies power to, for example, a traction motor (not shown) as the main equipment, driving this traction motor. Additionally, the driver 21 converts the alternating current supplied from the traction motor (i.e., the generator) into a direct current when the traction motor functions as a generator, and charges the high-voltage battery 1. The smoothing capacitor 22 has one terminal 22a electrically connected to a power supply line 4a, through which the electric power is supplied from the high-voltage battery 1 to the driver 21, and the other terminal 22b electrically connected to a ground line 4b. The smoothing capacitor 22 smoothens the voltage supplied from the high-voltage battery 1 to the driver 21. In the present disclosure, the driver 21 may also be referred to as a temperature-increase-side driver, and the smoothing capacitor 22 may also be referred to as a temperature-increase-side smoothing capacitor.

Furthermore, the temperature-increase device 2 in this embodiment can perform a battery temperature-increase operation that utilizes the heat generated by the internal resistance of the high-voltage battery 1, by turning the switching elements of the driver 21 on and off to charge and discharge the high-voltage battery 1, thereby increasing the temperature of the high-voltage battery 1.

The driver 21 includes a temperature-increase ECU 23. The temperature-increase ECU 23 includes a microcomputer that includes a processor and memory such as ROM and RAM, as well as its peripheral circuits. The temperature-increase ECU 23 controls the operation of the driver 21 by having the processor execute programs stored in the memory.

The high-voltage auxiliary device 3 is an onboard electric device that operates using power supplied from the high-voltage battery 1. High-voltage auxiliary device 3 in the present embodiment includes, for example, a driver 31 and a smoothing capacitor 32. The driver 31 is connected to the second electric circuit 5, which is connected in parallel to the first electric circuit 4. The driver 31 includes an inverter circuit including multiple switching elements. The driver 31 converts the direct current supplied from the high-voltage battery 1 into alternating current (specifically, three-phase alternating current) and supplies power to, for example, a motor for an electric compressor (not shown), driving the motor for the electric compressor. The driver 31 may not be limited to this example. The driver 31 may also supply power from the high-voltage battery 1 to high-voltage equipment, such as a high-voltage temperature-increase device (not shown), and drive the high-voltage equipment. In the present disclosure, the driver 31 may also be referred to as an auxiliary-side driver, and the smoothing capacitor 32 may also be referred to as an auxiliary-side smoothing capacitor.

The smoothing capacitor 32 has one terminal 32a that is electrically connected to the power supply wiring 5a through which the electric power is supplied from the high-voltage battery 1 to the high-voltage auxiliary device 3, and has the other terminal 32b is electrically connected to the ground wiring 5b. The smoothing capacitor 32 has a characteristic that the internal resistance value increases as the temperature is lower. The smoothing capacitor 32 is, for example, an electrolytic capacitor. It is intended to smoothen the voltage supplied from the high-voltage battery 1 to the driver 31. The electrolytic capacitor has a characteristic that the internal resistance increases as the temperature decreases. The smoothing capacitor 32 corresponds to an example of a smoothing capacitor.

The driver 31 includes an auxiliary ECU 33. The auxiliary ECU 33 includes a processor, a microcomputer including a memory such as ROM, RAM, and a peripheral circuit. The auxiliary ECU 33 controls the operation of the driver 31 by executing a program in which the processor is stored in the memory. The temperature-increase ECU 23 and the auxiliary ECU 33 are connected through, for example, an in-vehicle LAN (Local Area Network) like CAN (Controller Area Network) communication or wire harness.

In the configuration of the above-described onboard high-voltage system, in a low-temperature environment, the temperature-increase ECU 23 drives the driver 21 to carry out battery temperature-increase operation in order to prevent performance degradation of the high-voltage battery 1. However, when the battery temperature-increase operation is carried out, a ripple current also flows into the high-voltage auxiliary device 3 via the second electric circuit 5, which is connected in parallel to the first electric circuit 4. In a low-temperature environment, the internal resistance of the smoothing capacitor 32 increases, causing an excessive surge voltage to occur when ripple current flows in. If the voltage and current fluctuation caused by this surge voltage exceed the tolerance values of the components in the high-voltage auxiliary device 3 (for example, the voltage and current tolerance values of components including semiconductor elements such as IGBTs), it is possible that the components in the high-voltage auxiliary device 3 may degrade.

Therefore, in the first embodiment, prior to the implementation of the battery temperature-increase operation, the auxiliary ECU 33 conducts a warm-up operation to warm the smoothing capacitor 32. The warm-up operation involves the auxiliary ECU 33 turning the switching elements of the driver 31 on and off to charge and discharge the smoothing capacitor 32. This process utilizes the heat generated by the internal resistance to warm up the smoothing capacitor 32. As a result, the internal resistance value of the smoothing capacitor 32 is lowered, preventing the voltage and current fluctuation that occur during the battery temperature-increase operation from exceeding the tolerance values of the components in the high-voltage auxiliary device 3. The warm-up operation performed by the auxiliary ECU 33 is an example of a warm-up operation performed by the electronic control unit.

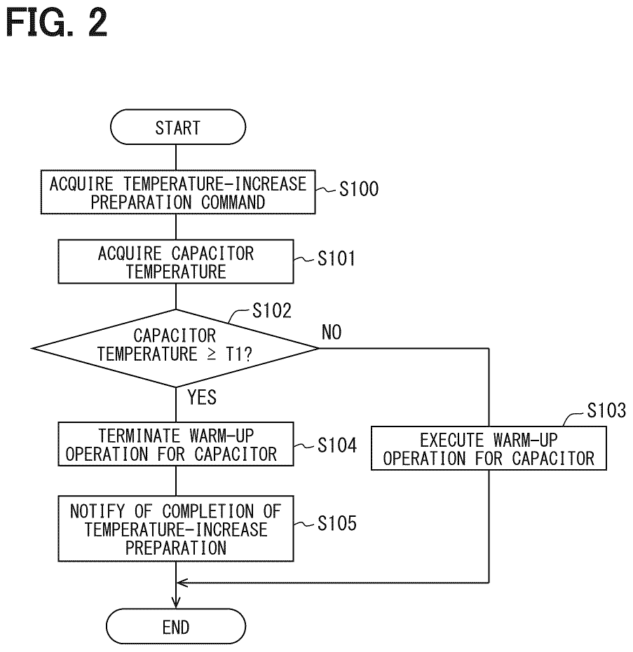

The following describes an example of a control process executed by the auxiliary ECU 33 in the high-voltage system according to the first embodiment with reference to a flowchart in FIG. 2.

First, in S100, the auxiliary ECU 33 receives a temperature-increase preparation command from the temperature-increase ECU 23. The temperature-increase preparation command is intended to notify the auxiliary ECU 33 in advance that the temperature-increase ECU 23 performs the battery temperature-increase operation by the driver 21.

Next, in S101, the auxiliary ECU 33 acquires the detected temperature of the smoothing capacitor 32. Subsequently, in S102, the auxiliary ECU 33 determines whether the detected temperature of the smoothing capacitor 32 is equal to or greater than a predetermined temperature threshold T1. The predetermined temperature threshold T1 corresponds to the temperature at which the internal resistance value of the smoothing capacitor 32 ensures that the surge voltage generated by the ripple current flowing into the high-voltage auxiliary device 3 during the battery temperature-increase operation remains within the tolerance values of the components in the high-voltage auxiliary device 3. A predetermined temperature threshold T1 is set in advance by experiments or the like, is stored in the memory of the auxiliary ECU 33.

If, in S102, it is determined that the detected temperature of the smoothing capacitor 32 is below the predetermined temperature threshold T1, the process proceeds to S103. In S103, the auxiliary ECU 33 performs a warm-up operation by turning the switching elements of the driver 31 on and off, thereby warming up the smoothing capacitor 32. At this time, the auxiliary ECU 33 carries out the warm-up operation with a warm-up capability such that the surge voltage generated during the warm-up operation at the detected temperature of the smoothing capacitor 32 does not exceed the tolerance values of the components within the high-voltage auxiliary device 3. This warm-up operation continues until the detected temperature of the smoothing capacitor 32 reaches or exceeds the predetermined temperature threshold T1. In the present disclosure, the term “warm-up capability” may also be referred to as a term “warm-up capacity”.

On the other hand, if in S102 it is determined that the detected temperature of the smoothing capacitor 32 is at or above the predetermined temperature threshold T1, the process proceeds to S104. In S104, the auxiliary ECU 33 either terminates the warm-up operation or proceeds without performing the warm-up operation, and then shifts the process to S105.

In S105, the auxiliary ECU 33 notifies the temperature-increase ECU 23 that the preparation on the high-voltage auxiliary device 3 side in response to the temperature-increase preparation command has been completed (i.e., the temperature-increase preparation is complete). Upon receiving the notification of temperature-increase preparation completion from the auxiliary ECU 33, the temperature-increase ECU 23 will start the battery temperature-increase operation.

The high-voltage system according the first embodiment described above has the following operational effects. In the first embodiment, prior to the execution of the battery temperature-increase operation, the auxiliary ECU 33 carries out a warm-up operation of the smoothing capacitor 32. This ensures that the voltage fluctuation or current fluctuation occurring in the high-voltage auxiliary device 3 during the battery temperature-increase operation do not exceed the tolerance values of the components of the high-voltage auxiliary device 3. it is possible to reduce the internal resistance value of the smoothing capacitor 32 and thereby lower the surge voltage that occurs when the ripple current flows into the high-voltage auxiliary device 3 during the battery temperature-increase operation. Therefore, this onboard high-voltage system can prevent the degradation of the components of the high-voltage auxiliary device 3 during the battery temperature-increase operation.

In the first embodiment, if the temperature of the smoothing capacitor 32 is below a predetermined temperature threshold T1, the auxiliary ECU 33 performs a warm-up operation prior to executing the battery temperature-increase operation. Accordingly, this prevents the battery temperature-increase operation from being executed when the temperature of the smoothing capacitor 32 is below the predetermined temperature threshold T1, thereby preventing the degradation of the components of the high-voltage auxiliary device 3.

In the first embodiment, the auxiliary ECU 33 performs the warm-up operation so that the detected temperature of the smoothing capacitor 32 reaches or exceeds the predetermined temperature threshold T1. Accordingly, if the temperature of the smoothing capacitor 32 reaches or exceeds the predetermined temperature threshold T1, the internal resistance value of the smoothing capacitor 32 is reduced. This prevents the surge voltage generated when the ripple current flows into the high-voltage auxiliary device 3 during the battery temperature-increase operation from becoming excessive. Therefore, this prevents the degradation of the components of the high-voltage auxiliary device 3 during the battery temperature-increase operation.

In the high-voltage system according to the first embodiment, multiple high-voltage auxiliary devices 3 may be electrically connected to the first electric circuit 4. In such a case, the warm-up operation involves each auxiliary ECU 33 of the multiple high-voltage auxiliary devices 3 warming up its own smoothing capacitor 32. Each auxiliary ECU 33 of the multiple high-voltage auxiliary devices 3 executes the warm-up operation with a warm-up capability that does not exceed the voltage and current tolerance of the components of its own high-voltage auxiliary device 3. The warm-up capability may also be referred to as a warm-up capacity. Accordingly, the auxiliary ECU 33 can execute the warm-up operation with a warm-up capability that is suited to the characteristics of the smoothing capacitor 32 and the components of its own high-voltage auxiliary device 3. The auxiliary ECU 33 may execute the warm-up operation with a warm-up capability such that the current and voltage fluctuation caused by the warm-up operation do not adversely affect the other high-voltage auxiliary devices 3. In the present disclosure, the voltage fluctuation may also be referred to as a voltage variation, and the current fluctuation may also be referred to as a current variation.

### First Modified Example of First Embodiment

In the first embodiment described above, the auxiliary ECU 33 compares the detected temperature of the smoothing capacitor 32 with a predetermined temperature threshold T1 in S101 and S102; however, it is not limited to this example. For example, the auxiliary ECU 33 may compare the temperature correlated with the temperature of the smoothing capacitor 32, and a predetermined temperature threshold.

### Second Modified Example of First Embodiment

In the first embodiment described above, the auxiliary ECU 33 performs the warm-up operation in S102 to S104 such that the detected temperature of the smoothing capacitor 32 reaches or exceeds the predetermined temperature threshold T1; however, it is not limited to this example. For example, the auxiliary ECU 33 may perform the warm-up operation such that a temperature correlated with the temperature of the smoothing capacitor 32 reaches or exceeds a predetermined temperature threshold.

### Third Modified Example of First Embodiment

In the first embodiment described above, the auxiliary ECU 33 performs the warm-up operation in S103 with a warm-up capability such that the surge voltage generated during the warm-up operation at the detected temperature of the smoothing capacitor 32 does not exceed the tolerance values of the components of the high-voltage auxiliary device 3; however, it is not limited to this example. For example, the auxiliary ECU 33 may start the warm-up operation with a warm-up capability such that the voltage fluctuation or current fluctuation generated when the warm-up operation is performed at the lower limit of the operating temperature of the smoothing capacitor 32 are within the tolerance values of the components of the high-voltage auxiliary device 3. Alternatively, the auxiliary ECU 33 may initiate warm-up from the minimum warm-up capability of the warm-up operation.

### Second Embodiment

The following describes a second embodiment of the present disclosure. The second embodiment is similar to the first embodiment, except for change made to part of the control processing performed by the auxiliary ECU 33 in the first embodiment; thus, difference from the first embodiment only is described below.

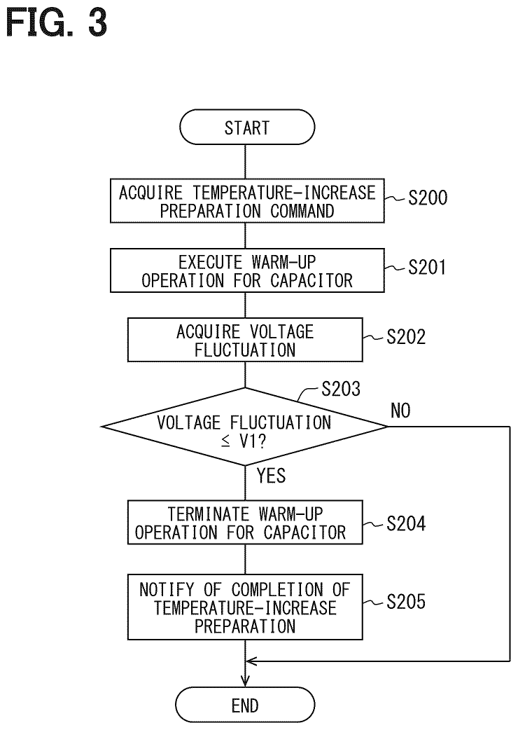

The following describes an example of a control process executed by the auxiliary ECU 33 in the high-voltage system according to the second embodiment with reference to a flowchart in FIG. 3.

First, in S200, the auxiliary ECU 33 receives a temperature-increase preparation command from the temperature-increase ECU 23.

In S201, the auxiliary ECU 33 performs a warm-up operation by turning the switching elements of the driver 31 on and off, thereby warming up the smoothing capacitor 32.

Subsequently, the auxiliary ECU 33 in S202 acquires the voltage fluctuation generated in the high-voltage auxiliary device 3 during the warm-up operation. The auxiliary ECU 33 is capable of acquiring the voltage fluctuation from such a voltage detection circuit (not shown) provided in the high-voltage auxiliary device 3. In S203, the auxiliary ECU 33 determines whether the voltage fluctuation occurring in the high-voltage auxiliary device 3 during the warm-up operation are is equal to or lower than a predetermined voltage threshold V1. The predetermined voltage threshold V1 is set in advance through experiments or other methods and is stored in the memory of the auxiliary ECU 33. The predetermined voltage threshold V1 is the voltage generated in the high-voltage auxiliary device 3 during the warm-up operation by the driver 31 when the auxiliary capacitor is at a “predetermined temperature or a predetermined internal resistance value”. The “predetermined temperature or a predetermined internal resistance value” is the temperature or internal resistance value of the auxiliary capacitor voltage fluctuation or current fluctuation generated in the high-voltage auxiliary device 3 during battery temperature-increase operation by the driver 21 is not exceeding the tolerance value of each component having the high-voltage auxiliary device 3.

In other words, if it is determined that the voltage fluctuation generated in the high-voltage auxiliary device 3 during the warm-up operation by the driver 31 are below the predetermined voltage threshold V1, it is estimated that the smoothing capacitor 32 has reached a temperature above the predetermined level or an internal resistance value below the predetermined level. In that case, the voltage fluctuation or current fluctuation generated in the high-voltage auxiliary device 3 during the battery temperature-increase operation by the driver 21 will not exceed the tolerance values of the components of the high-voltage auxiliary device 3.

If it is determined in S203 that the voltage fluctuation occurring in the high-voltage auxiliary device 3 during the warm-up operation exceed the predetermined voltage threshold V1, the process is temporarily terminated. Then, after the predetermined control time has elapsed, the process from S200 to S203 is executed again. In other words, if the voltage fluctuation occurring in the high-voltage auxiliary device 3 during the warm-up operation exceed the predetermined voltage threshold V1, the warm-up operation is continued.

On the other hand, if it is determined in S203 that the voltage fluctuation occurring in the high-voltage auxiliary device 3 during the warm-up operation are below the predetermined voltage threshold V1, the process proceeds to S204. In S204, the auxiliary ECU 33 terminates the warm-up operation and proceeds to S205.

In S205, the auxiliary ECU 33 notifies the temperature-increase ECU 23 that the preparation on the high-voltage auxiliary device 3 side in response to the temperature-increase preparation command has been completed (i.e., temperature-increase preparation is complete). Upon receiving the notification of temperature-increase preparation completion from the auxiliary ECU 33, the temperature-increase ECU 23 will start the battery temperature-increase operation.

The high-voltage system according the second embodiment described above has the following operational effects. In the second embodiment, the auxiliary ECU 33 performs the warm-up operation until the voltage fluctuation occurring in the high-voltage auxiliary device 3 during the warm-up operation are below the predetermined voltage threshold V1. Accordingly, the voltage fluctuation occurring in the high-voltage auxiliary device 3 during the warm-up operation are correlated with the internal resistance value of the smoothing capacitor. Therefore, if the voltage fluctuation occurring in the high-voltage auxiliary device 3 during the warm-up operation fall below the predetermined voltage threshold V1, it indicates that the internal resistance value of the smoothing capacitor 32 has decreased. As a result, it prevents the surge voltage generated when the ripple current flows into the high-voltage auxiliary device 3 during battery temperature-increase operation from becoming excessively high. Therefore, by preventing the battery temperature-increase operation from being carried out when the internal resistance value of the smoothing capacitor 32 is high, it is possible to prevent the components of the high-voltage auxiliary device 3 from degradation during the battery temperature-increase operation.

### First Modification of Second Embodiment

In the above second embodiment, the auxiliary ECU 33 performs the warm-up operation until the voltage fluctuation occurring in the high-voltage auxiliary device 3 during the warm-up operation fall below the predetermined voltage threshold V1 in S202 to S204. However, this is not limited to this example. For example, the auxiliary ECU 33 may perform the warm-up operation until the current fluctuation occurring in the high-voltage auxiliary device 3 during the warm-up operation reach or exceed a predetermined current threshold. Accordingly, the current fluctuation occurring in the high-voltage auxiliary device 3 during the warm-up operation are correlated with the internal resistance value of the smoothing capacitor. Therefore, if the current fluctuation occurring in the high-voltage auxiliary device 3 during the warm-up operation is above the predetermined current threshold, it indicates that the internal resistance value of the smoothing capacitor 32 has decreased. As a result, it prevents the surge voltage generated when the ripple current flows into the high-voltage auxiliary device 3 during battery temperature-increase operation from becoming excessively high. Therefore, this prevents the degradation of the components of the high-voltage auxiliary device 3 during the battery temperature-increase operation.

### Third Embodiment

The following describes a third embodiment of the present disclosure. In the first and second embodiments described above, prior to the execution of the battery temperature-increase operation, the auxiliary ECU 33 performs a warm-up operation to warm up the smoothing capacitor 32. In contrast, in the third embodiment, prior to the execution of the battery temperature-increase operation, the temperature-increase ECU 23 performs a temperature-increase limitation operation to warm up the smoothing capacitor 32. The temperature-increase limitation operation involves switching the switching elements of the driver 21 on and off at a lower warm-up capability compared to the battery temperature-increase operation, thereby passing a controlled ripple current through the smoothing capacitor 32. This process uses the heat generated by the internal resistance to warm up the smoothing capacitor 32. The temperature-increase limitation operation executed by the temperature-increase ECU 23 is also an example of a warm-up operation carried out by an electronic control unit.

The configuration of the high-voltage system in the third embodiment is substantially identical to the configuration described in the first embodiment, except that the temperature-increase ECU 23 is capable of performing the temperature-increase limitation operation prior to the battery temperature-increase operation.

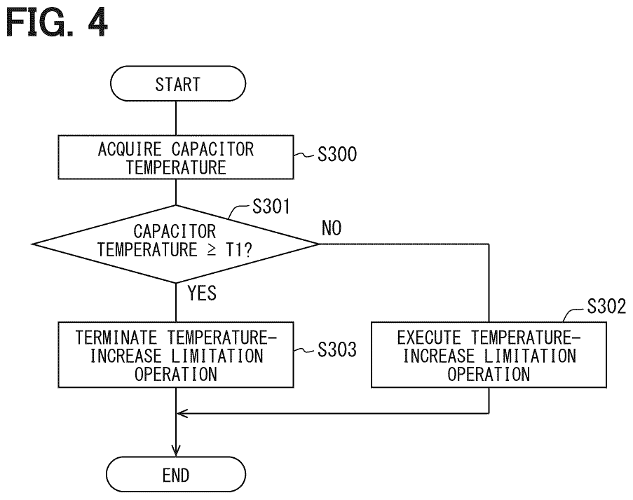

In the high-voltage system according to the third embodiment, an example of the control processing executed by the temperature-increase ECU 23 will be explained with reference to the flowchart in FIG. 4.

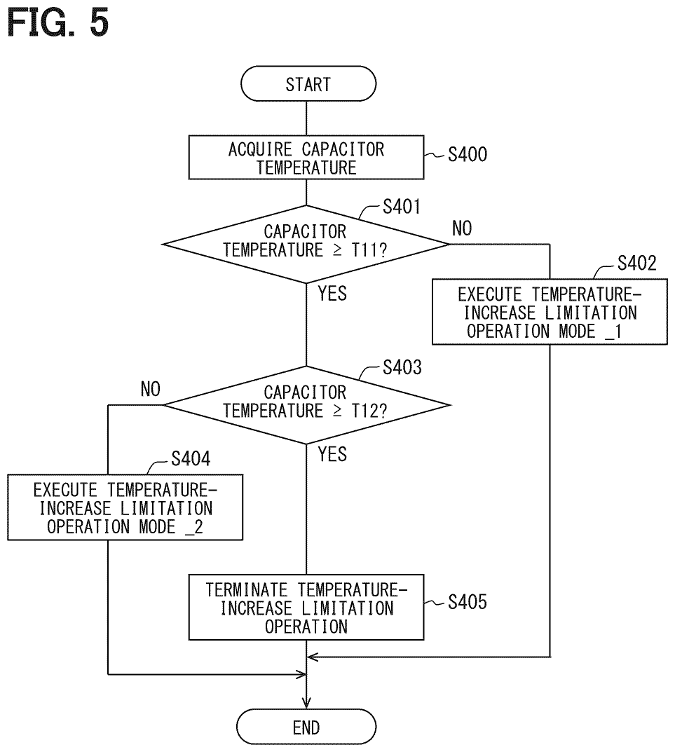

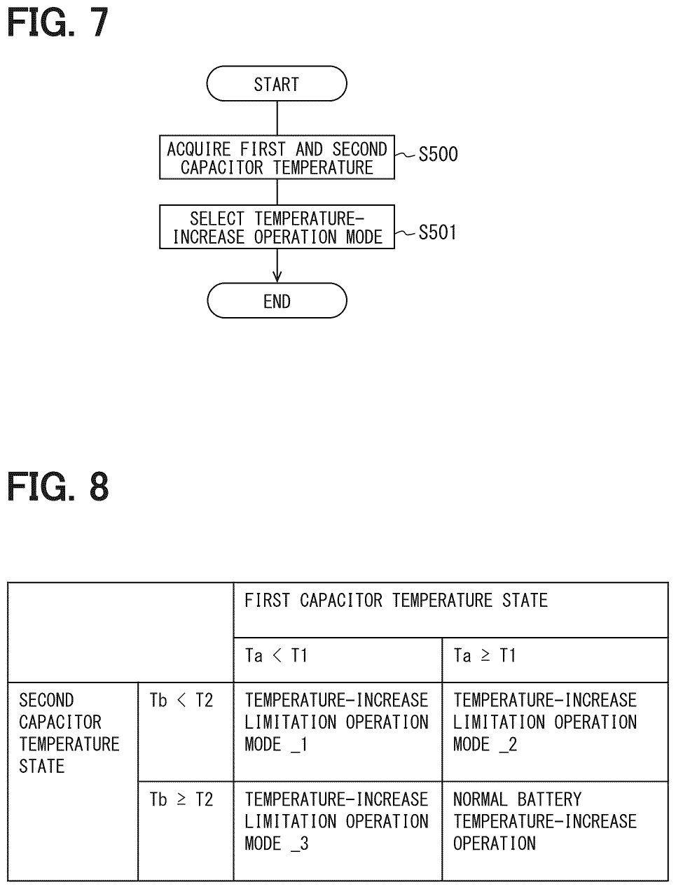

First, in S300, the temperature-increase ECU 23 obtains the detected temperature of the smoothing capacitor 32 from the auxiliary ECU 33 prior to performing the battery temperature-increase operation. In FIG. 4, the detected temperature of the smoothing capacitor 32 is simply referred to as “capacitor temperature.” This also applies to FIGS. 5 and 7.

Next, in S301, the temperature-increase ECU 23 determines whether the detected temperature of the smoothing capacitor 32 is equal to or higher than a predetermined temperature threshold T1. The predetermined temperature threshold T1, similar to what was described in the first embodiment, corresponds to the temperature at which the internal resistance value of the smoothing capacitor 32 ensures that the surge voltage generated by the ripple current flowing into the high-voltage auxiliary device 3 during the battery temperature-increase operation remains equal to or below the tolerance value of the components of the high-voltage auxiliary device 3. The predetermined temperature threshold T1 is stored in the memory of the temperature-increase ECU 23 or the auxiliary ECU 33 is set in advance by experiments or the like.

If it is determined in S301 that the detected temperature of the smoothing capacitor 32 is below the predetermined temperature threshold T1, the process proceeds to S302. In S302, the temperature-increase ECU 23 performs the temperature-increase limitation operation by turning the switching elements of the driver 21 on and off to warm up the smoothing capacitor 32. At this time, the temperature-increase ECU 23 performs the temperature-increase limitation operation with a temperature-increase capability that ensures the surge voltage generated during the temperature-increase limitation operation at the detected temperature of the smoothing capacitor 32 does not exceed the tolerance values of the components of the high-voltage auxiliary device 3. This temperature-increase limitation operation continues until the detected temperature of the smoothing capacitor 32 reaches or exceeds the predetermined temperature threshold T1. The temperature-increase capability may also be referred to as an temperature-increase capacity.

On the other hand, if in S301 it is determined that the detected temperature of the smoothing capacitor 32 is at or above the predetermined temperature threshold T1, the process proceeds to S303. In S303, the temperature-increase ECU 23 either terminates the temperature-increase limitation operation or transitions to the normal battery temperature-increase operation without performing the temperature-increase limitation operation.

The high-voltage system according the third embodiment described above has the following operational effects. In the third embodiment, prior to executing the battery temperature-increase operation, the temperature-increase ECU 23 performs the temperature-increase limitation operation to warm up the smoothing capacitor 32. This temperature-increase limitation operation ensures that the voltage fluctuation or current fluctuation occurring in the high-voltage auxiliary device 3 during the battery temperature-increase operation do not exceed the tolerance values of the components of the high-voltage auxiliary device 3. It is possible to reduce the internal resistance value of the smoothing capacitor 32 and thereby lower the surge voltage that occurs when the ripple current flows into the high-voltage auxiliary device 3 during the battery temperature-increase operation. Therefore, this onboard high-voltage system can prevent the degradation of the components of the high-voltage auxiliary device 3 during the battery temperature-increase operation.

In the third embodiment, if the temperature of the smoothing capacitor 32 is below a predetermined temperature threshold T1, the temperature-increase ECU 23 performs the temperature-increase limitation operation prior to executing the battery temperature-increase operation. Accordingly, this prevents the battery temperature-increase operation from being executed when the temperature of the smoothing capacitor 32 is below the predetermined temperature threshold T1, thereby preventing the degradation of the components of the high-voltage auxiliary device 3.

In the third embodiment, the temperature-increase ECU 23 performs the temperature-increase limitation operation so that the detected temperature of the smoothing capacitor 32 reaches or exceeds the predetermined temperature threshold T1. Accordingly, if the temperature of the smoothing capacitor 32 reaches or exceeds the predetermined temperature threshold T1, the internal resistance value of the smoothing capacitor 32 is reduced. This prevents the surge voltage generated when the ripple current flows into the high-voltage auxiliary device 3 during the battery temperature-increase operation from becoming excessive. Therefore, this prevents the degradation of the components of the high-voltage auxiliary device 3 during the battery temperature-increase operation.

### First Modified Example of Third Embodiment

In the third embodiment described above, the temperature-increase ECU 23 compares the detected temperature of the smoothing capacitor 32 with a predetermined temperature threshold T1 in S301; however, it is not limited to this example. For example, the temperature-increase ECU 23 may compare the temperature correlated with the temperature of the smoothing capacitor 32, and a predetermined temperature threshold.

### Second Modified Example of the Third Embodiment

In the third embodiment described above, the temperature-increase ECU 23 performs the temperature-increase limitation operation in S301 to S303 such that the detected temperature of the smoothing capacitor 32 reaches or exceeds the predetermined temperature threshold T1; however, it is not limited to this example. For example, the temperature-increase ECU 23 may perform the temperature-increase limitation operation such that a temperature correlated with the temperature of the smoothing capacitor 32 reaches or exceeds a predetermined temperature threshold.

### Third Modified Example of Third Embodiment

In the third embodiment, in S302, the temperature-increase ECU 23 performs the temperature-increase limitation operation with a temperature-increase capability for ensuring that the surge voltage generated during the temperature-increase limitation operation at the detected temperature of the smoothing capacitor 32 does not exceed the tolerance values of the components of the high-voltage auxiliary device 3. However, it is not limited to this example. For example, the temperature-increase ECU 23 may initiate the temperature-increase limitation operation with a temperature-increase capability for ensuring that the voltage fluctuation or current fluctuation generated when performing the temperature-increase limitation operation at the lower limit of the operating temperature of the smoothing capacitor 32 does not exceed the tolerance values of the components of the high-voltage auxiliary device 3. Alternatively, the temperature-increase ECU 23 may start the temperature-increase limitation operation from the minimum temperature-increase capability of the temperature-increase limitation operation.

### Fourth Embodiment

The following describes a fourth embodiment. The fourth embodiment is similar to the third embodiment, except for change made to part of the control processing performed by the temperature-increase ECU 23 in the third embodiment; thus, difference from the third embodiment only is described below.

In the fourth embodiment, multiple temperature thresholds and temperature-increase limitation operation modes are set for the smoothing capacitor 32.

In the high-voltage system according to the fourth embodiment, an example of the control processing executed by the temperature-increase ECU 23 will be explained with reference to the flowchart in FIG. 5.

First, in S400, the temperature-increase ECU 23 obtains the detected temperature of the smoothing capacitor 32 from the auxiliary ECU 33 prior to performing the battery temperature-increase operation.

Next, in S401, the temperature-increase ECU 23 determines whether the detected temperature of the smoothing capacitor 32 is equal to or higher than a first temperature threshold T11. The first temperature threshold T11 corresponds to the temperature at which the internal resistance value of the smoothing capacitor 32 ensures that the surge voltage generated by a ripple current I1 being smaller than the ripple current flowing into the high-voltage auxiliary device 3 during the battery temperature-increase operation remains within the tolerance values of the components in the high-voltage auxiliary device 3. The first temperature threshold T11 is stored in the memory of the temperature-increase ECU 23 or the auxiliary ECU 33 is set in advance by experiments or the like.

If it is determined in S401 that the detected temperature of the smoothing capacitor 32 is below the first temperature threshold T11, the process proceeds to S402. In S402, the temperature-increase ECU 23 executes the temperature-increase limitation operation mode_1. The temperature-increase limitation operation mode_1 is an operation mode where the surge voltage generated by the ripple current flowing into the high-voltage auxiliary device 3 is suppressed when the temperature-increase limitation operation is performed with the temperature of the smoothing capacitor 32 being below the first temperature threshold T11. Specifically, the temperature-increase limitation operation mode_1 is an operation mode in which the ripple current is suppressed so that the surge voltage generated by the ripple current flowing into the high-voltage auxiliary device 3 during this operation remains below the tolerance values of the various components of the high-voltage auxiliary device 3. This temperature-increase limitation operation mode_1 is carried out until the detected temperature of the smoothing capacitor 32 reaches or exceeds the first temperature threshold T11.

On the other hand, if it is determined in S401 that the detected temperature of the smoothing capacitor 32 is equal to or greater than the first temperature threshold T11, the process proceeds to S403.

In S403, the temperature-increase ECU 23 determines whether the detected temperature of the smoothing capacitor 32 is equal to or greater than a second temperature threshold T12. The second temperature threshold T2 corresponds to the temperature at which the internal resistance value of the smoothing capacitor 32 ensures that the surge voltage generated by the ripple current flowing into the high-voltage auxiliary device 3 during the battery temperature-increase operation remains within the tolerance values of the components in the high-voltage auxiliary device 3. The second temperature threshold T12 is also stored in the memory of the temperature-increase ECU 23 or the auxiliary ECU 33 is set in advance by experiments or the like.

If it is determined in S403 that the detected temperature of the smoothing capacitor 32 is below the second temperature threshold T12, the process proceeds to S404. In S404, the temperature-increase ECU 23 executes the temperature-increase limitation operation mode_2. The temperature-increase limitation operation mode_2 is an operation mode with higher capability than the temperature-increase limitation operation mode_1, conducted during the battery temperature-increase operation such that the ripple current flowing into the high-voltage auxiliary device 3 does not exceed a lower ripple current 11. Additionally, the temperature-increase limitation operation mode_2 can be described as an operation mode in which the ripple current flowing into the high-voltage auxiliary device 3 is suppressed when the temperature-increase limitation operation is performed under the condition that the temperature of the smoothing capacitor 32 is equal to or greater than the first temperature threshold T11 and less than the second temperature threshold T12. Specifically, the temperature-increase limitation operation mode_2 is an operation mode in which the ripple current is suppressed so that the surge voltage generated by the ripple current flowing into the high-voltage auxiliary device 3 during this operation remains below the tolerance values of the various components of the high-voltage auxiliary device 3. This temperature-increase limitation operation mode_2 is carried out until the detected temperature of the smoothing capacitor 32 reaches or exceeds the second temperature threshold T12.

On the other hand, if it is determined in S403 that the detected temperature of the smoothing capacitor 32 is equal to or greater than the second temperature threshold T12, the process proceeds to S405. In S405, the temperature-increase ECU 23 either terminates the temperature-increase limitation operation or transitions to the normal battery temperature-increase operation without performing the temperature-increase limitation operation.

The high-voltage system according the fourth embodiment described above has the following operational effects. In the fourth embodiment, the temperature-increase ECU 23 executes control that incrementally or continuously increases the temperature-increase capability during the temperature-increase limitation operation based on the temperature of the smoothing capacitor 32. Accordingly, by incrementally or continuously increasing the temperature-increase capability during the temperature-increase limitation operation, it is possible to shorten the time required for the temperature-increase limitation operation. As a result, it becomes possible to start the battery temperature-increase operation more quickly in low-temperature environments and to increase the temperature of the high-voltage battery 1 in a shorter period of time. The first temperature threshold T11 described in the fourth embodiment can also be referred to as a low-temperature threshold T11, and the second temperature threshold T12 described in the fourth embodiment can also be referred to as a high-temperature threshold T12.

### Modified Example of Fourth Embodiment

In the fourth embodiment described above, the temperature-increase limitation operation mode is set to two stages. However, it is not limited to this example. The temperature-increase limitation operation mode can be set to three stages or more.

### Fifth Embodiment

The following describes a fifth embodiment. The fifth embodiment is similar to the third and fourth embodiments, except for change made to part of the control processing performed by the temperature-increase ECU 23 in the third and fourth embodiments; thus, difference from the third and fourth embodiments only is described below.

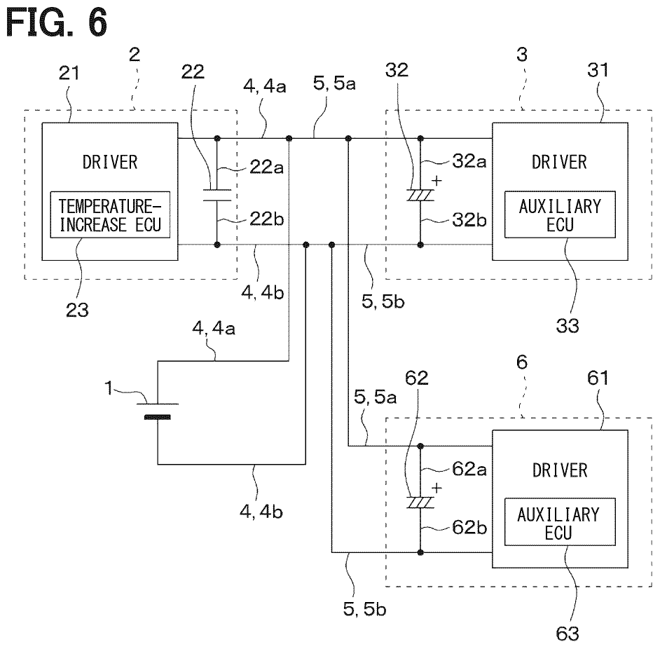

As shown in FIG. 6, in a fifth embodiment, the high-voltage system includes multiple high-voltage auxiliary devices 3 and 6. The multiple high-voltage auxiliary devices 3 and 6 are, for example, an electric compressor and a high-voltage heating device for air conditioning. In the following description, one of the multiple high-voltage auxiliary devices 3 and 6 is referred to as the first high-voltage auxiliary device 3, and the other high-voltage auxiliary device 6 is referred to as the second high-voltage auxiliary device 6. Additionally, the first high-voltage auxiliary device 3 includes a driver 31, a smoothing capacitor 32, and an auxiliary ECU 33. The driver 31 may also be referred to as a first driver 31. The smoothing capacitor 32 may also be referred to as a first capacitor 32. The auxiliary ECU 33 may also be referred to as a first auxiliary ECU 33. The second high-voltage auxiliary device 6 includes a driver 61, a smoothing capacitor 62, and an auxiliary ECU 63. The driver 61 may also be referred to as a second auxiliary-side driver. The smoothing capacitor 62 may also be referred to as a second auxiliary-side capacitor. The auxiliary ECU 63 may also be referred to as a second auxiliary ECU 63. The second capacitor 62 has one terminal 62a electrically connected to a power supply line 5a, through which power is supplied from the high-voltage battery 1 to the high-voltage auxiliary device 3, and the other terminal 62b electrically connected to a ground line 5b. The second capacitor 62, like the first capacitor 32, has the characteristic that its internal resistance increases as the temperature decreases. The second capacitor 62 is also, for example, an electrolytic capacitor. The second capacitor 62 also corresponds to an example of a smoothing capacitor.

In an onboard high-voltage system, when the temperature-increase device 2 performs battery temperature-increase operation, current fluctuation and voltage fluctuation caused by switching occur, which raises concerns that components of the multiple high-voltage auxiliary devices 3 and 6 may degrade. Additionally, between the first high-voltage auxiliary device 3 and the second high-voltage auxiliary device 6, the tolerance surge voltage for each component, the temperature characteristics related to the internal resistance of the smoothing capacitor, and the degree of temperature increase of the smoothing capacitor during warm-up may differ. In this case, even if the temperature of one of the multiple smoothing capacitors (i.e., the first capacitor 32 and the second capacitor 62) is sufficiently warmed up, there may be instances where the temperature of the other smoothing capacitor is not sufficiently warmed up. At this time, if the system transitions to normal battery temperature-increase operation when only one capacitor's temperature is sufficiently warmed up, an excessive surge voltage may occur in the other high-voltage auxiliary device 3, raising concerns that the components of the other high-voltage auxiliary device 3 may degrade.

Therefore, in the fifth embodiment, when the high-voltage system includes multiple high-voltage auxiliary devices 3 and 6, a temperature threshold is set for each of smoothing capacitors 32 and 62 that each of the multiple high-voltage auxiliary devices 3 and 6 possesses. Additionally, a temperature-increase limitation operation mode is set according to the temperature states of the smoothing capacitors 32 and 62 included in the multiple high-voltage auxiliary devices 3 and 6, respectively. The first temperature threshold T1 and the second temperature threshold T2 used in the explanation of the fifth embodiment are different from the first temperature threshold T11 (in other words, the low-temperature threshold T11) and the second temperature threshold T12 (in other words, the high-temperature threshold T12) used in the explanation of the fourth embodiment. In a case where the high-voltage system includes the multiple high-voltage auxiliary devices 3 and 6, the first temperature threshold T1 and the second temperature threshold T2 used in the fifth embodiment are temperature thresholds set for the smoothing capacitors 32, 62 included in the multiple high-voltage auxiliary devices 3 and 6, respectively.

In the high-voltage system according to the fifth embodiment, an example of the control processing executed by the temperature-increase ECU 23 will be explained with reference to the flowchart in FIG. 7 and the table in FIG. 8.

First, in S500, the temperature-increase ECU 23 obtains the detected temperature Ta of the first capacitor 32 from the first auxiliary ECU 33 and the detected temperature Tb of the second capacitor 62 from the second auxiliary ECU 63, prior to implementing the battery temperature-increase operation.

In S501, the temperature-increase ECU 23 compares the detected temperature Ta of the first capacitor 32 with the first temperature threshold T1, and further compares the detected temperature Tb of the second capacitor 62 with the second temperature threshold T2. Then, the temperature-increase ECU 23 selects and implements a temperature-increase limitation operation mode in accordance with the combination of the temperature states of the multiple smoothing capacitors (i.e., the first capacitor 32 and the second capacitor 62) and the temperature-increase limitation operation modes, as shown in the table in FIG. 8.

Here, the first temperature threshold T1 is the temperature at which the surge voltage generated in the first high-voltage auxiliary device 3, due to the ripple current flowing into the first capacitor 32 during the battery temperature-increase operation, remains below the tolerance value for each component of the first high-voltage auxiliary device 3. The first temperature threshold T1 may be the same value as the predetermined temperature threshold T1 used in the descriptions of the first and third embodiments and their variations, or it may be a different value. Here, the second temperature threshold T2 is the temperature at which the surge voltage generated in the first high-voltage auxiliary device 3, due to the ripple current flowing into the second capacitor 62 during the battery temperature-increase operation, remains below the tolerance value for each component of the second high-voltage auxiliary device 6.

The temperature-increase limitation operation modes_1, _2, and _3 are as follows. They are operation modes in which the ripple current is suppressed in combinations of the temperature state of the first capacitor 32 and the temperature state of the second capacitor 62, such that the surge voltage generated during the temperature-increase limitation operation does not exceed the withstand voltage and withstand current of all the components of the high-voltage auxiliary devices 3 and 6. Specifically, the temperature-increase limitation operation modes_2 and _3 are configured with a higher temperature-increase capability compared to temperature-increase limitation operation mode_1.

According to the table in FIG. 8, the temperature-increase ECU 23 executes temperature-increase limitation operation mode_1 when the detected temperature Ta of the first capacitor 32 is below the first temperature threshold T1 and the detected temperature Tb of the second capacitor 62 is below the second temperature threshold T2.

The temperature-increase ECU 23 executes temperature-increase limitation operation mode_2 when the detected temperature Ta of the first capacitor 32 is above or equal to the first temperature threshold T1, and the detected temperature Tb of the second capacitor 62 is below the second temperature threshold T2.

The temperature-increase ECU 23 executes temperature-increase limitation operation mode_3 when the detected temperature Ta of the first capacitor 32 is below the first temperature threshold T1, and the detected temperature Tb of the second capacitor 62 is above or equal to the second temperature threshold T2.

The temperature-increase ECU 23 executes the normal battery temperature-increase operation when the detected temperature Ta of the first capacitor 32 is above or equal to the first temperature threshold T1, and the detected temperature Tb of the second capacitor 62 is above or equal to the second temperature threshold T2.

The high-voltage system according the fifth embodiment described above has the following operational effects. In the fifth embodiment, the high-voltage system includes multiple high-voltage auxiliary devices 3 and 6. The temperature-increase ECU 23 executes a temperature-increase limitation operation mode that ensures the warm-up capability does not exceed the withstand voltages and withstand currents of components possessed by all the high-voltage auxiliary devices 3 and 6. Accordingly, the temperature-increase ECU 23 can set the optimal temperature-increase limitation operation mode based on the temperature conditions of the smoothing capacitors 32 and 62 in the multiple high-voltage auxiliary devices 3 and 6. This allows for the prevention of degradation to components in all the high-voltage auxiliary devices 3 and 6 while also shortening the time required to complete the temperature-increase limitation operation. Furthermore, the temperature-increase ECU 23 can simultaneously warm the smoothing capacitors 32 and 62 in the multiple high-voltage auxiliary devices 3 and 6 solely through the operation of the driver 21. Therefore, compared to the case where the auxiliary ECUs 33 and 63 in the multiple high-voltage auxiliary devices 3 and 6 individually perform the warming operation, it is easier to suppress electrical interference between the multiple high-voltage auxiliary devices 3 and 6.

### Modified Example of Fifth Embodiment

In the fifth embodiment described above, the high-voltage system includes two high-voltage auxiliary devices 3 and 6. However, it is not limited to this example. The system may include three or more high-voltage auxiliary devices. In the fifth embodiment, the three temperature-increase limitation operation modes_1, _2, _3 are described. However, the system may also include four or more temperature-increase limitation operation modes.

### Sixth Embodiment

The following describes a sixth embodiment. The sixth embodiment is similar to the third and fifth embodiments, except for change made to part of the control processing performed by the temperature-increase ECU 23 in the third and fifth embodiments; thus, difference from the third and fifth embodiments only is described below.

In the sixth embodiment, the temperature-increase ECU 23 changes the temperature-increase capability during the temperature-increase limitation operation by referring to the voltage fluctuation occurring in the high-voltage auxiliary device 3. This is because the voltage and current fluctuation occurring in the high-voltage auxiliary device 3 during the temperature-increase limitation operation change according to the internal resistance of the smoothing capacitor 32. Therefore, there is a correlation between the internal resistance of the smoothing capacitor 32 and the voltage fluctuation occurring in the high-voltage auxiliary device 3 during the temperature-increase limitation operation.

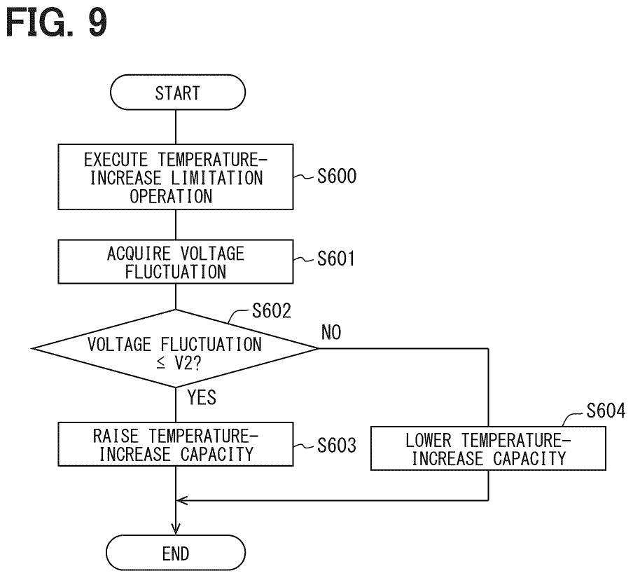

In the high-voltage system according to the sixth embodiment, an example of the control processing executed by the temperature-increase ECU 23 will be explained with reference to the flowchart in FIG. 9.

In S600, the temperature-increase ECU 23 performs the temperature-increase limitation operation prior to executing the battery temperature-increase operation, thereby warming up the smoothing capacitor 32.

In S601, the temperature-increase ECU 23 acquires the voltage fluctuation occurring in the high-voltage auxiliary device 3 during the temperature-increase limitation operation from the auxiliary ECU 33.

In S602, the temperature-increase ECU 23 determines whether the voltage fluctuation occurring in the high-voltage auxiliary device 3 during the temperature-increase limitation operation is below a predetermined voltage threshold V2. The predetermined voltage threshold V2 is the tolerance voltage fluctuation value of each component in the high-voltage auxiliary device 3 (for example, the withstand voltage value of semiconductor elements such as IGBTs), or a value that includes a margin relative to that tolerance value. The predetermined voltage threshold V2 is set in advance through experiments or other methods and is stored in the memory of the temperature-increase ECU 23.

In S602, if it is determined that the voltage fluctuation occurring in the high-voltage auxiliary device 3 during the temperature-increase limitation operation exceed the predetermined voltage threshold V2, the process proceeds to S604. In S604, the temperature-increase ECU 23 reduces the temperature-increase capability of the temperature-increase limitation operation.

On the other hand, if it is determined in S602 that the voltage fluctuation occurring in the high-voltage auxiliary device 3 during the temperature-increase limitation operation is equal to or below the predetermined voltage threshold V2, the process proceeds to S603. In S603, the temperature-increase ECU 23 increases the temperature-increase capability of the temperature-increase limitation operation.

The high-voltage system according the sixth embodiment described above has the following operational effects. In the sixth embodiment, the temperature-increase ECU 23 executes control to gradually or continuously increase the temperature-increase capability while performing the temperature-increase limitation operation in such a way that the voltage fluctuation occurring in the high-voltage auxiliary device 3 during the temperature-increase limitation operation remain equal to or below the predetermined voltage threshold V2. Accordingly, by incrementally or continuously increasing the temperature-increase capability during the temperature-increase limitation operation, it is possible to shorten the time required for the temperature-increase limitation operation. As a result, it becomes possible to start the battery temperature-increase operation more quickly in low-temperature environments and to increase the temperature of the high-voltage battery 1 in a shorter period of time.

### Modification of Sixth Embodiment

In the above sixth embodiment, the heating ECU 23 compares the voltage fluctuation occurring in the high-voltage auxiliary device 3 during the temperature-increase limitation operation with a predetermined voltage threshold V2 in S601 and S602. However, it is not limited to this example. For example, the temperature-increase ECU 23 may compare the current fluctuation occurring in the high-voltage auxiliary device 3 during the temperature-increase limitation operation with a predetermined current threshold. Accordingly, the current fluctuation occurring in the high-voltage auxiliary device 3 during the temperature-increase limitation operation are correlated with the internal resistance value of the smoothing capacitor 32. The modified example of the sixth embodiment achieves the same effects as the sixth embodiment.

### Other Embodiments

In the above embodiments, the temperature-increase device 2 has been exemplified as one that supplies power to the main unit, but it is not limited to this. The temperature-increase device 2 may also be configured, for example, as a high-voltage auxiliary device, a boost converter, or a DC-DC converter.

In the above embodiments, the high-voltage auxiliary devices 3 and 6 have been exemplified as an electric compressor and a high-voltage heating device, but they are not limited to these. The high-voltage auxiliary devices 3 and 6 may also be various electric devices installed in the vehicle.

In the above embodiments, the auxiliary ECU 33, 63 and the temperature-increase ECU 23 have been exemplified as electronic control units, but the electronic control units are not limited to these. The electronic control units may be configured as ECUs separate from the auxiliary ECU 33, 63 and the temperature-increase ECU 23. That is to say, the warm-up operation and the temperature-increase limitation operation are not limited to being controlled by the auxiliary ECU 33, 63 and the temperature raising ECU 23; they may also be executed under the control of another ECU.

In the above embodiments, the driver 21 and the drivers 31, 61 have been described as inverter circuits, but they are not limited to this example. They may also be various electric circuits with switching elements.

In the above embodiments, electrolytic capacitors have been exemplified as the smoothing capacitors 32, 62, but they are not limited to this example. Various types of capacitors may be used as long as they have the characteristic of higher internal resistance at lower temperatures.

The present disclosure is not limited to the above embodiments and each modification, it is possible to specially change. The above-described embodiments and modified examples are not irrelevant to each other, and can be appropriately combined with each other unless the combination is obviously impossible. The constituent element(s) of each of the above embodiments and modified examples is/are not necessarily essential unless it is specifically stated that the constituent element(s) is/are essential in the above embodiment, or unless the constituent element(s) is/are obviously essential in principle. In each of the embodiments and modified examples, when a numerical value such as the number, numerical value, amount, or range of the constituent elements of the embodiment is mentioned, the numerical value is not limited to a specific number unless otherwise specified as essential or obviously limited to the specific number in principle. In each of the embodiments and modified examples, when referring to the shape, positional relationship, and the like of the constituent elements and the like, the shape, positional relationship, and the like are not limited unless otherwise specified or limited to a specific shape, positional relationship, and the like in principle.

The electronic control unit and the technique according to the present disclosure may be achieved by a dedicated computer provided by constituting a processor and a memory programmed to execute one or more functions embodied by a computer program. Alternatively, the electronic control unit and the technique according to the present disclosure may be achieved by a dedicated computer provided by constituting a processor with one or more dedicated hardware logic circuits. Alternatively, the electronic control unit and the method described in the present disclosure may be implemented by one or more special purpose computer, which is configured as a combination of a processor and a memory, which are programmed to perform one or more functions, and a processor which is configured with one or more hardware logic circuits. The computer program may be stored in a computer-readable non-transitory tangible recording medium as an instruction executed by a computer.

What is claimed is:

1. An onboard high-voltage system configured to be adapted to a vehicle, the onboard high-voltage system comprising:
a high-voltage battery configured to store and release electric power;
a temperature-increase device connected to the high-voltage battery via an electric circuit, the temperature-increase device configured to execute a battery temperature-increase operation to increase a temperature of the high-voltage battery, the battery temperature-increase operation being an operation in which the temperature-increase device controls the high-voltage battery to store and release the electric power by turning on and off a switching element of the temperature-increase device;
a high-voltage auxiliary device electrically connected to the electric circuit, the high-voltage auxiliary device configured to be driven by the electric power supplied from the high-voltage battery;
a smoothing capacitor having a terminal connected to a power supply wiring and another terminal connected to a ground wiring, the power supply wiring through which the electric power is supplied from the high-voltage battery to the high-voltage auxiliary device, the smoothing capacitor with an internal resistance value that increases as a temperature of the smoothing capacitor decreases; and
an electronic control unit configured to execute a warm-up operation prior to execution of the battery temperature-increase operation to warm up the smoothing capacitor included in the high-voltage auxiliary device and prevent a voltage fluctuation or a current fluctuation from exceeding a tolerance value of each of components in the high-voltage auxiliary device, the warm-up operation being an operation in which a switching element of the high-voltage auxiliary device or the switching element of the temperature-increase device is turned on and off.

2. The onboard high-voltage system according to claim 1, wherein
the electronic control unit is configured to execute the warm-up operation prior to the execution of the battery temperature-increase operation, on a condition that the temperature of the smoothing capacitor included in the high-voltage auxiliary device or a temperature correlated to the temperature of the smoothing capacitor is lower than a predetermined temperature threshold.

3. The onboard high-voltage system according to claim 1, wherein
the electronic control unit is configured to execute the warm-up operation to increase the temperature of the smoothing capacitor included in the high-voltage auxiliary device or a temperature correlated to the temperature of the smoothing capacitor to be higher than or equal to a predetermined temperature threshold.

4. The onboard high-voltage system according to claim 1, wherein
the electronic control unit is configured to execute the warm-up operation until a situation in which a voltage fluctuation occurred in the high-voltage auxiliary device during the warm-up operation is lower than or equal to a predetermined voltage threshold or a current fluctuation occurred in the high-voltage auxiliary device during the warm-up operation is higher than or equal to a predetermined current threshold.

5. The onboard high-voltage system according to claim 1, wherein
the electronic control unit is configured to raise a warm-up capacity of the warm-up operation incrementally or continuously based on the temperature of the smoothing capacitor included in the high-voltage auxiliary device or a temperature correlated to the temperature of the smoothing capacitor in the warm-up operation.

6. The onboard high-voltage system according to claim 1, wherein
the electronic control unit is configured to:
execute the warm-up operation to decrease a voltage fluctuation occurred in the high-voltage auxiliary device during the warm-up operation being lower than or equal to a predetermined voltage threshold or increase a current fluctuation occurred in the high-voltage auxiliary device during the warm-up operation being higher than or equal to a predetermined current threshold; and
raise a warm-up capacity of the warm-up operation incrementally or continuously in the warm-up operation.

7. The onboard high-voltage system according to claim 1, wherein
the electronic control unit is configured to:
start the warm-up operation with a predetermined warm-up capacity or a minimum warm-up capacity of the warm-up operation, the predetermined warm-up capacity being a capacity to decrease a voltage fluctuation or a current fluctuation during the warm-up operation being equal to or lower than a tolerance value of each component of the high-voltage auxiliary device, the predetermined warm-up capacity being adopted at a lower limit value of an operating temperature of the smoothing capacitor included in the high-voltage auxiliary device; and
raise the warm-up capacity incrementally or continuously in the warm-up operation.

8. The onboard high-voltage system according to claim 1, wherein
the high-voltage auxiliary device is one of high-voltage auxiliary devices that are electrically connected to the electric circuit,
the warm-up operation includes a temperature-increase limitation operation that is lower in temperature-increase capacity than the battery temperature-increase operation executed by the temperature-increase device,
the temperature-increase limitation operation is an operation in which the switching element of the temperature-increase device is turned on and off, and
the electronic control unit is configured to execute a temperature-increase limitation operation mode of the temperature-increase limitation operation with a temperature-increase capacity that does not cause a withstand voltage and a withstand current in each of components of all of the high-voltage auxiliary devices to be exceeded.

9. The onboard high-voltage system according to claim 1, wherein
the high-voltage auxiliary device is one of high-voltage auxiliary devices that are electrically connected to the electric circuit,
the warm-up operation is an operation in which respective switching elements of the high-voltage auxiliary devices are turned on and off to warm up respective smoothing capacitors of the high-voltage auxiliary devices, and
the electronic control unit is configured to execute the warm-up operation with a warm-up capacity that does not cause a withstand voltage and a withstand current in a component of each of the high-voltage auxiliary devices to be exceeded.

10. An electronic control unit configured to be adapted to an onboard high-voltage system having a high-voltage battery, a smoothing capacitor, a high-voltage auxiliary device, and a temperature-increase device, the temperature-increase device being connected to the high-voltage battery via an electric circuit, the high-voltage auxiliary device being connected to the electric circuit, the smoothing capacitor having a terminal connected to a power supply wiring and another terminal connected to a ground wiring, the power supply wiring through which electric power is supplied from the high-voltage battery to the high-voltage auxiliary device, the electronic control unit comprising:
at least one of (i) a circuit or (ii) a processor having a memory storing computer program code, wherein
the at least one of the circuit or the processor having the memory is configured to cause the onboard high-voltage system to:
execute a warm-up operation to warm up the smoothing capacitor included in the high-voltage auxiliary device by turning on and off a switching element of the high-voltage auxiliary device or a switching element of the temperature-increase device, prior to the temperature-increase device executing a battery temperature-increase operation to control the high-voltage battery to release and store electric power by turning on and off the switching element of the temperature-increase device; and
prevent a voltage fluctuation or a current fluctuation occurred in the high-voltage auxiliary device during the battery temperature-increase operation from exceeding a tolerance value of each component in the high-voltage auxiliary device.
